(19) United States
(12) Patent Application Publication
(10) Pub. No.: US 2014/0311037 A1
(43) Pub. Date: Oct. 23, 2014

(54) GUARDIAN GARAGE GATE AND PET KENNEL

(71) Applicant: Sandie Russo, Beaverton, OR (US)

(72) Inventor: Sandie Russo, Beaverton, OR (US)

(21) Appl. No.: 13/865,322

(22) Filed: Apr. 18, 2013

(51) Int. Cl. A01K 1/03; E06B 9/02

(52) U.S. Cl. CPC A01K 1/034; E06B 9/02
USPC 49/464

(57) ABSTRACT

A garage gate system for creating a kennel environment comprising: a first side post; a second side post, where the first side post and the second side post detachably engage a garage door; a series of gates between the first side post and the second side post; and a post separately each gate in the series of gates. Preferably, each gate includes a plurality of equally spaced vertical bars although methods of enclosure are contemplated. In one particular embodiment, each gate includes a screen covering. The vertical bars may be made from at least one of aluminum and bamboo.

### BACKGROUND OF THE INVENTION

1. Field of Invention

The present invention relates to a gate that is installed on a standard garage door panel that provides a means to create a pet kennel within the garage in a convenient manner.

2. Description of Related Art

The prior art includes various configurations and modifications of the traditional garage door. Some systems have shown use of garage door screens that cover the entire garage opening with a screen configuration and also having a means to allow entry and exit from the garage through the screen. Usually the traditional garage door screen is assembled over the entire opening into the garage door. These screens are used as a substitute for the traditional garage door and allow for the flow of air into the garage. Further partial screens have been developed for garage doors where the screen is integrated into a portion of the garage door, again typically to allow the flow of air into the garage during use thereof. An example of a combined garage door screen and door is disclosed in U.S. Pat. No. 5,860,465 which shows the use of a garage door where the screen is fixed and attached to the back of the garage door so that it lowers as the garage door is opened partially to create air flow for the garage.

Many times pet owners may desire to leave their pets in the garage while they are away from the premises. Use of the garage as such may even create a kennel environment if there is more than one pet housed at the residence. Consequently it would be advantageous to have a method to integrate a system that creates a gate system so that pets may comfortable remain in the garage.

### SUMMARY OF THE INVENTION

The present invention relates to a garage gate system for creating a kennel environment comprising: a first side post; a second side post, where the first side post and the second side post detachably engage a garage door; a series of gates between the first side post and the second side post; and a post separately each gate in the series of gates. Preferably, each gate includes a plurality of equally spaced vertical bars although methods of enclosure are contemplated. In one particular embodiment, each gate includes a screen covering. The vertical bars may be made by a variety of products, including but not limited to aluminum and bamboo.

### BRIEF DESCRIPTION OF DRAWINGS

FIG. 1 depicts a gate garage system integrated into a traditional garage door in accordance with the present invention.

### DETAILED DESCRIPTION

The present invention relates to a garage gate system that is integrated into a garage door. The garage gate system according to present invention allows for the ingress and egress of pets through the gates, which are attached on the lower portion of the traditional garage door. The present invention enables a pet owner to create a convenient kennel environment within the garage. The present invention creates a gate system at the lower portion of the garage door. When the gate system is not in use it travels with the garage door panel and is locked into place with pins. Therefore the gate moves in accordance with the garage door as needed. Conveniently the gate system may be detached from the garage door and the garage door is unlocked to lift and open up the garage door opening. The gate remains on the ground level and it is secured by a bolting pin system. The gate system provides a means to secure the pets within the garage area but allows the garage door to be completely opened and therefore the owner may have free access to go into and out of the garage door. Once the garage door is lowered the gate may be engaged with the garage door again for use as an enclosed kennel. Use of the gate system creates a full size gate kennel for an owner's pets while the owner may leave the premises. This system prevents the pet's owner from having to place the pet into a tight kennel, crate or pen that may be normally used. The gate system also may be disengaged and laid to rest flat on the ground for the owner to walk freely over the gate with any materials, packaging or other items that they may desire to move into and out of the garage.

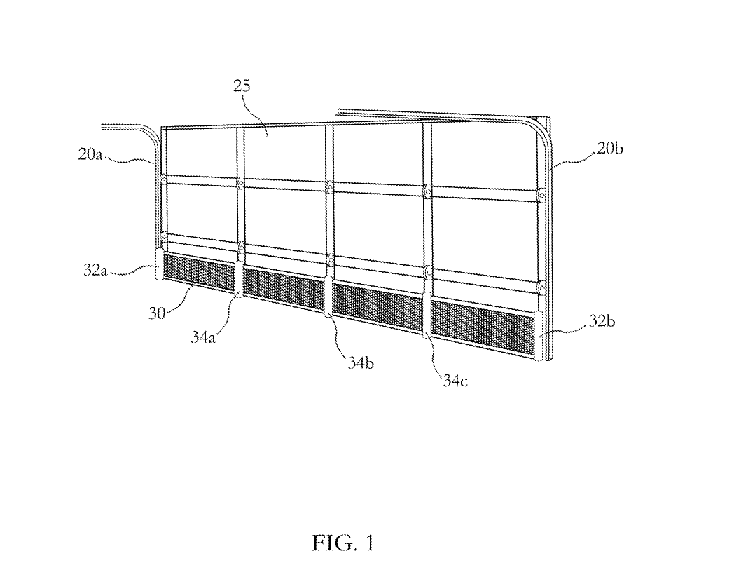

In reference to FIG. 1 use of a garage gate system 30 in accordance with the present invention is depicted. The garage gate system 30 according to present invention includes a first side 32a and a second side 32b. These side posts 32a, 32 b shown at each side of the garage gate system 30 engage the gate system 30 with a garage door 25. Further the gate system 30 may be disengaged from the garage door allowing the user to raise the garage door 25 in an elevated position along the tracks 20a, 20b as shown in FIG. 1. The garage door 25 is also shown in FIG. 1 that is depicted as a conventional garage door usually associated with a two-car garage. Posts 34a, 34b, 34c divide the gate system 30 into four sections only for shipping. The gate system may include the use of additional posts, fencing or other gated material. As depicted in FIG. 1, an optional screen system may optionally be installed along the gated sections, which would be an optional feature in accordance with the present invention.

In one particular embodiment a series of vertical bars are used to create the gated sections of the gate system 30. Further the actual vertical bars may be manufactured of aluminum, bamboo or other suitable materials to secure vertical positioning but also to provide the permanent purpose of creating an enclosed kennel for the pets. Further the gated sections may be manufactured of suitable width such as 8 feet, 9 feet or 16 feet to accommodate various standard garage door width sizes. The 3½″ gap has been tested on very small dogs and normal size cats. The space between the vertical bars may be sufficiently small so ensure that the pets remain within the garage area. The garage gate system according to present invention would be ideal for small pets to ensure that an open kennel environment is created within the garage space that is secure and safe for the pet. The instant invention has been shown and described in what it considers to be the most practical and preferred embodiments. It is recognized, however, that departures may be made there from within the scope of the invention and that obvious modifications will occur to a person skilled in the art.

What is claimed is:

1. A garage gate system for creating a kennel environment comprising:
a. a first side post;
b. a second side post, where the first side post and the second side post detachably engage a garage door;
c. a series of gates between the first side post and the second side post; and
d. a post separately each gate in the series of gates.

2. The garage gate system according to claim 1, where each gate includes a plurality of equally spaced vertical bars.

3. The garage gate system according to claim 1, where each gate includes a screen covering.

4. The garage gate system according to claim 2, where the vertical bars are made from at least one of aluminum and bamboo.
